(19) United States
(12) Patent Application Publication
(10) Pub. No.: US 2026/0178270 A1
(43) Pub. Date: Jun. 25, 2026

(54) AUDIO-ENHANCED TRANSACTION INTERFACE FOR SELF-SERVICE TERMINALS (SSTs)

(71) Applicant: NCR Voyix Corporation, Atlanta, GA (US)

(72) Inventors: Kip Oliver Morgan, Atlanta, GA (US); Gina Torcivia Bennett, Lawrenceville, GA (US); WuChieh James Jong, Raleigh, NC (US); Erfan Khaki, Alpharetta, GA (US)

(21) Appl. No.: 18/990,672

(22) Filed: Dec. 20, 2024

(51) Int. Cl. G06F 3/16; G06F 9/451; G06Q 20/18

(52) U.S. Cl. CPC G06F 3/167; G06F 9/453; G06Q 20/18

(57) ABSTRACT

Methods and system for improving accessibility of self-service terminals for users with visual impairments through enhanced text-to-speech functionality. The system detects headphone insertion into a universal navigator device and automatically switches to an accessibility mode. The system provides specialized audio feedback for navigable interface elements, incorporating customizable spoken descriptions and metadata while managing conflicting audio streams. The system implements a hierarchical approach to audio feedback, prioritizing critical transaction information while maintaining context through specific audio cues for different interface element types. This creates an efficient, user-friendly transaction experience for customers with visual impairments.

### BACKGROUND

Self-checkout user interfaces present significant challenges for visually impaired individuals due to the extensive information displayed that is not confined to just buttons. When a visually impaired person attempts to navigate a self-checkout kiosk, the experience can be difficult and frustrating. The lack of clear guidance after inserting headphones at a self-service terminal creates confusion. Critical information displayed in areas that cannot be traditionally navigated poses accessibility barriers. Standard workflow audio prompts often conflict with navigation guidance, while button placement and navigation order are typically not optimized for audio-only users. Additionally, button text may not be ideally suited for spoken feedback, and there is often uncertainty whether accessibility functionality is properly implemented or functioning.

### BRIEF DESCRIPTION OF THE DRAWINGS

FIG. 1A is a diagram of a system for an audio-enhanced transaction interface for service terminals (SSTs), according to an example embodiment.

FIG. 1B is a diagram depicting a user interface (UI) screen with hidden audio instructions for audio guidance being associated with a UI element, according to an example embodiment.

FIG. 1C is a diagram depicting a UI screen with enhanced audio guidance for a UI element brought into focus by a user within the UI screen, according to an example embodiment.

FIG. 1D illustrates diagrams for a pair of UI screens with audio guidance before a user selects a given UI element from a first UI screen and after the user selects the UI element rendered in a second UI screen, according to an example embodiment.

FIG. 2 is a flow diagram of a method for an audio-enhanced transaction through a transaction interface of an SST, according to an example embodiment.

FIG. 3 is a flow diagram of another method for an audio-enhanced transaction through a transaction interface of an SST, according to an example embodiment.

### DETAILED DESCRIPTION

Self-service terminals (SSTs) present significant accessibility challenges that extend beyond basic interface navigation. Users with visual impairments face substantial difficulties when attempting to complete transactions at these terminals, particularly due to the complex nature of information presentation.

The traditional audio feedback mechanisms at SSTs create confusion and inefficiency. When workflow audios play simultaneously with navigation guidance, the overlapping sounds create an unclear and frustrating experience. Additionally, critical transaction information displayed in non-navigable areas of the interface becomes inaccessible to visually impaired users.

Button placement and navigation sequences within the interface are typically designed for visual interaction, making them suboptimal for audio-only users. The text displayed on buttons often lacks sufficient context when converted to speech, and additional descriptive information necessary for users remains absent from the interface. Furthermore, users with visual impairments have no clear indication whether accessibility features are properly implemented or functioning, leading to uncertainty and reduced confidence in using self-service terminals independently.

The techniques presented herein leverage existing universal navigator control hardware to create an enhanced accessibility experience. When headphones are inserted into the audio jack, the system automatically adapts to provide specialized audio feedback tailored for users with visual impairments.

The methods presented herein implement a novel audio management system that suppresses standard workflow and price audios when an audio accessibility mode is activated, replacing them with contextually appropriate navigation-focused audio feedback. This technique ensures clear communication of interface elements without conflicting audio streams.

In embodiments presented herein, instruction areas become focusable controls, allowing visually impaired users to access previously unreachable information. The system employs special metadata for each control containing text, enabling customized spoken feedback that provides additional context beyond the displayed text.

The techniques presented herein incorporate an intelligent audio interruption system that prioritizes critical transaction information. When an item is sold, the current audio gracefully fades out, and detailed item information is conveyed before resuming the previous audio context. This hierarchical approach ensures that essential transaction details are never missed while maintaining user orientation within the interface.

In embodiments presented herein, the navigation experience is enhanced through specialized audio cues that distinguish between different types of interface elements. Buttons are clearly identified as selectable elements, and additional guidance is provided about available navigation options. This systematic approach creates a complete audio representation of the visual interface, enabling users with visually impairments to complete transactions efficiently and independently.

As used herein, the usage of the terms “user, “operator,” and “customer,” and/or “consumer” may be used synonymously and interchangeably. That is, an individual who is performing a transaction at an SST while utilizing an audio accessibility feature or option associated with providing automated speech guidance through a user's headset during the transaction.

As used herein, an “input control device” and/or an “input navigation device” may be used synonymously and interchangeable. This is a device operated by a user during a transaction at an SST to navigate transaction interface screens and select user interface (UI) elements. In an embodiment, the input control/navigation device is a universal navigator device that comprises 4 directional arrow keys and sides and an enter or select button in a center the device. The input navigation device is a peripheral of the SST and further includes an audio jack for insertion of a cord associated with a user's headset.

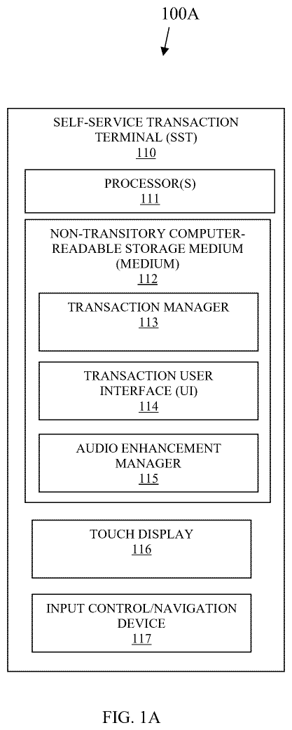

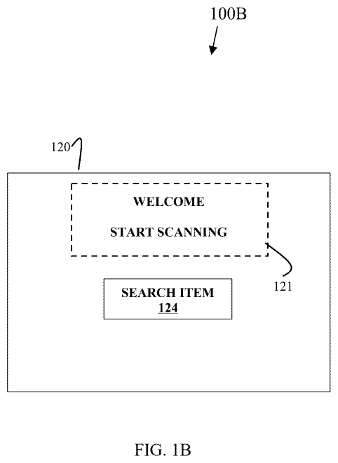

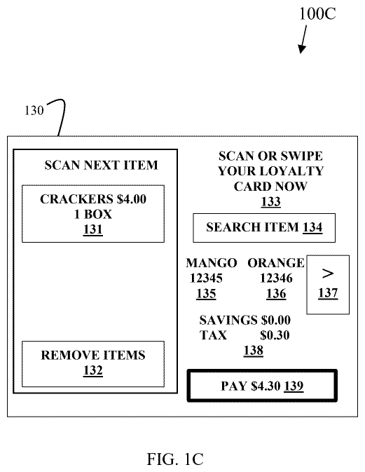

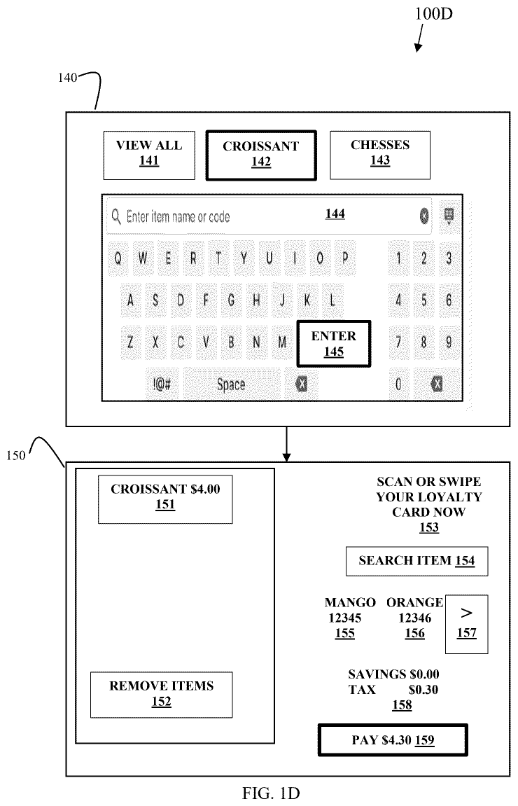

FIG. 1A is a diagram of a system 100A for an audio-enhanced transaction interface for SSTs, according to an example embodiment. Notably, the components are shown schematically in greatly simplified form, with only those components relevant to understanding of the embodiments being illustrated.

Furthermore, the various components (that are identified in system/platform 100A) are illustrated and the arrangement of the components are presented for purposes of illustration only. It is to be noted that other arrangements with more or less components are possible without departing from the teachings of providing an audio-enhanced transaction interface for SSTs, presented herein and below.

System 100A includes an SST 110. The SST 110 includes at least one processor 111 and a non-transitory computer-readable storage medium (medium) 112, which includes instructions for a transaction manager 113, a transaction UI 114, and an audio enhancement manager 115. The instructions when executed by the processor 111 cause the processor to perform operations discussed herein and below with respect to transaction manager 113, transaction UI 114, and audio enhancement manager 115. SST 110 also includes a touch display 116 and an input control/navigation device 117.

Notably, the SST 110 includes a variety of other peripheral devices which are not illustrated in FIG. 1A. For example, the SST 110 may include a card reader, a barcode scanner, a handheld scanner, a weigh scale, a combined barcode reader and weigh scale, a receipt printer, a currency acceptor, a currency dispenser, a bag well weigh scale, one or more wireless transceivers, a personal identification number (PIN) pad, and other peripherals.

Most conventional interfaces of SSTs include accessibility options for individuals that have disabilities and are unable to effectively operate the SSTs for self-checkouts. Once common accessibility feature is audio feedback or guidance during the self-checkouts. It is noted that there are a variety of other accessibility features for those with a variety of disabilities. Most governments mandate that retailers provide a minimum level of accessibility features to customers that are in need of them. In the case of conventional audio guidance, usability by customers is challenging as discussed at length above. These challenges are substantially mitigated by the teachings presented herein.

Transaction manager 113 is responsible for managing and processing a self-service transaction of a customer at SST 110. Transaction manager 113 processes and presents transaction UI 114 on interface screens presented on touch display 116.

Conventionally, a user has to affirmatively select a UI element associated with accessing the accessibility features of an SST. The techniques presented herein automatically selects an audio guidance accessibility feature upon detection of a user's headset being plugged into an audio jack of the input control device 117. This places the transaction UI 114 in a text-to-speech mode controlled by audio enhancement manager 115.

When transaction manager 113 or audio enhancement manager 115 receives an event from the input control device 117 indicating that a listening device (e.g., user's headset) was plugged into the audio jack of the input control device 117, audio enhancement manager 115 monitors the transaction screens rendered by the transaction UI 114 and the corresponding UI elements that the user brings into focus within any given screen for purposes of providing audio feedback and guidance to the user while the user interacts with the transaction UI 114 and transaction manager 113 to perform a self-service transaction on the SST 110. Audio enhancement manager 115 places the transaction UI 114 in a text-to-speech audio guidance mode responsive to the listening device being plugged into the audio jack of input control device 117.

When audio enhancement manager 115 detects the listening device, all sounds and audio during the transaction are routed to the listening device. Existing audio workflows are typically preassigned to the UI screens and UI interface elements, the audio enhancement manager suppresses and controls the playing of audio from the workflow during a transaction to provide enhanced audio navigation guidance to users with visual impairments. For example, when a transaction is started, an existing workflow audio will play audio of “welcome—please scan your first item.” With the enhanced audio navigation guidance, audio enhancement manager 115 the instruction area associated with the UI element text for the welcome —scan your first item becomes a first focusable control by the input control device 117. As a result, audio enhancement manager is able to play audio or speak the hierarchical children of the section.

This is achieved by adding special metadata to each control that includes text in the UI screens. For example, with the displayed text is “welcome” on a welcome UI screen and the existing audio workflow is set to speak “welcome—please scan your first item,” the audio enhancement manager 115 uses the metadata to override the workflow speech and speaks “welcome to store X—navigate to start transaction or scan item to begin.” This metadata is not hardcoded and can be translated to other natural spoken languages (e.g., French, German, etc.), this can be done with any other text in the application.

If the speak-able text is empty (e.g., not associated with overriding metadata) on a UI screen, the audio enhancement manager 115, the text as it appears on the UI screen is spoken to the user instead. However, when the UI element is a selectable button, the audio enhancement manager 115 adds a spoken word “button” to the audio feedback provided to the user along with speech about selecting the button and navigating away from the button. Again, the added enhanced spoken text for the selectable button and navigation options can be provided in any natural language being used by the user during the transaction. For example, when the user operates the input control device 117 to navigate to a “Pay” button or UI element within a given UI screen, the audio enhancement manager speaks “pay button, press center key to select, press arrow keys for other options.”

Another significant part of enhancing a user with a visual impairment UI experience is reading item descriptions, price, and any details (e.g., discounts, restrictions, etc.) after an item is sold. Because selling an item is an important operation at the time, the audio will always be played and cannot be interrupted by any existing audio workflow. Accordingly, audio enhancement manager 115 always interrupts the currently playing audio by having the currently playing audio quickly fade out so it does not sound clipped. The audio enhancement manager 115 replays the audio that was faded out from its beginning when the item selling audio is completely spoken to the user.

While picklist buttons or picklist UI elements have descriptions and are read when navigated to by the audio enhancement manager 115, if the user presses the select key on the input control device 117, the item will sell and be added to the user's item list for the transaction, which causes audio enhancement manager 115 to play and speak the item selling audio immediately when the select key is pressed. For example, when a user navigates to avocados, audio enhancement manager 115 speaks the name of the avocado and its price lookup number (PLU), if the existing audio workflow is set to do speak the PLU. If the user selects the avocado, the item sells, causing audio enhancement manager 115 to stop playing the existing audio workflow, and the audio enhancement manager 115 immediately plays or speaks audio for the item description, price, and details. When the audio enhancement manager finishes speaking the details, the existing audio workflow's audio will be played and spoken to the user from its beginning as if the user had just navigated to the UI element or button associated with the avocados. This provides the user with context to where on the screen the user was after an item sells. This same behavior of the audio enhancement manager 115 occurs for barcode scanning of items with barcodes. The user's current location within a UI screen is always spoken again after an item sale so that the user is repetitively informed as to their current location within the UI screen.

Knowing what to do after scanning and selling an item for a user with visual impairment can be complex because certain payment features are often enabled on the SST 110 and not obvious to the user. Thus, additional guidance can be added to the metadata of certain UI buttons to provide the user with the information; for example, the pay button is enhanced to cause the audio enhancement manager 115 to speak “swipe card at any time to pay.”

Audio enhancement manager 113 interrupts less important existing audio from existing audio workflows to play more useful and important audio feedback for the user. This ensures that the user hears about important things that are not normally navigated to by the user. This provides a visually impaired user a full picture and context of what is being displayed in front of them on a given UI screen. With this extra help, the user can complete a transaction in a timely manner without assistance, creating a win-win situation for both the shopper/user and the retailer.

System 100 provides a method to group instruction text and display areas of UI screens into navigation zones that can be highlighted by an input control device 117. Further, system 100 provides a technique and method for overriding text on navigation zones for more visually impaired friendly text. Metadata is added to UI buttons and other navigation zones for additional text to be spoken after the displayed or overridden text is read to the user. Less important reading or audio is interrupted, such as the contexts of a picklist button, for more important speech such as an item's name and price just scanned or sold.

System 100 permits more users with visual impairments to utilize SSTs 110, which will reduce labor costs for a retailer due to a decrease in manned point-of-sale (POS) terminals by cashiers. System 100 goes beyond existing compliance with accessibility laws and regulations, which gives retailers adopting system 100 a competitive advantage in certain regions of the world. Furthermore, throughput of customers with visual impairments at the SSTs 110 and customer satisfaction are improved with system 100. A retailer adopting system 100 will also experience goodwill for going beyond current compliance rules to assist customers with visual impairments. Moreover, a retailer adopting system 100 is likely to experience a higher net promoter score (NPS), which is a measure of customer loyalty and satisfaction.

FIG. 1B is a diagram depicting a UI screen with hidden audio instructions for audio guidance being associated with a UI element, according to an example embodiment. Initially, a customer with a sight impairment approaches SST 110 for a self-service transaction. Transaction UI 114 renders welcome screen 120 on the touch display 116.

A navigable zone is defined by 120 and associated with non-hardcoded metadata, which audio enhancement manager 115 uses to override an existing workflow audio to provide customized audio feedback to the user. For example, instead of an existing audio playing “welcome, please scan your first item to begin;” audio enhancement manager 115 uses the metadata to override the existing audio and play “welcome to store X, scan your first item to begin.”

FIG. 1C is a diagram depicting a UI screen with enhanced audio guidance for a UI element brought into focus by a user within the UI screen, according to an example embodiment.

UI screen 130 illustrates a situation in which the user has scanned a box of crackers identified as UI element 131. The UI screen 130 also illustrates a variety of other UI elements. The selectable UI elements include remove items 132, search item 134, a mango item 135, an orange item 163, a next item 137, and pay button 139. The non-selectable UI elements include scan or swipe your loyalty card now 133 savings and tax 138.

A user has brought into focus the pay button 139 in UI screen 130 when this occurs and existing audio will speak to the user “pay $4.30.” However, additional speak-able metadata associated with a selectable button causes audio enhancement manager 115 to add spoken words after “pay $4.30” the words “press the center key to select, press arrow keys for other options.” This is repetitively done for selectable buttons during a transaction to reinforce what the user is expected to do when the user has navigated to a selectable UI button within a given UI screen. It is to be noted that the actual natural language spoken can be for any language that is set for the transaction.

UI screen 130 illustrates a situation in which the user has scanned a box of crackers identified as UI element 131. The UI screen 130 also illustrates a variety of other UI elements. The selectable UI elements include remove items 132, search item 134, a mango item 135, an orange item 163, a next item 137, and pay button 139. The non-selectable UI elements include scan or swipe your loyalty card now 133 savings and tax 138.

FIG. 1D illustrates diagrams for a pair of UI screens with audio guidance before a user selects a given UI element from a first UI screen and after the user selects the UI element rendered in a second UI screen, according to an example embodiment. UI screen 140 illustrates selectable UI elements for a view all items 141, a croissant 142, cheeses 143, a keyboard input field 144 for manually entering item search data by name or item code. The keyboard further includes an enter key 145. UI screen illustrates a situation in which the user has selected croissant 142 and pressed the enter key 145.

Once the user selects the croissant button 142, the audio enhancement manager 115 begins to play the existing audio workflow and its audio which begins to read “French Croissant PLU number . . . ,” and is cut off after the user presses the enter button or key 145 with audio enhancement manager 115 immediately beginning to read “one French Croissant $4.00 when transaction interface 114 renders screen 150.

UI screen 150 includes selectable UI elements for croissant 151, remove items 152, search item 154, mango 155, orange 156, next produce item in list 157, and pay button 159. UI screen includes non-selectable UI elements scan or swipe your loyalty card now 153 and savings and tax 158. Assuming the user does not press the pay button 159, the audio enhancement manager 115 will play the existing workflows audio for the selected croissant details from the beginning back to the user. If the user selects the pay button 159, the audio enhancement manager 115 transactions to audio feedback and guidance associated with payment screens rendered by the transaction UI 114.

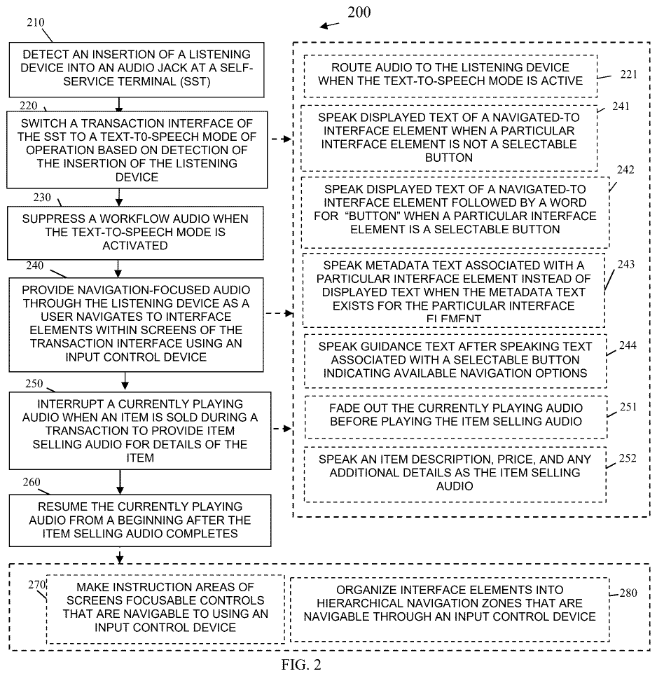

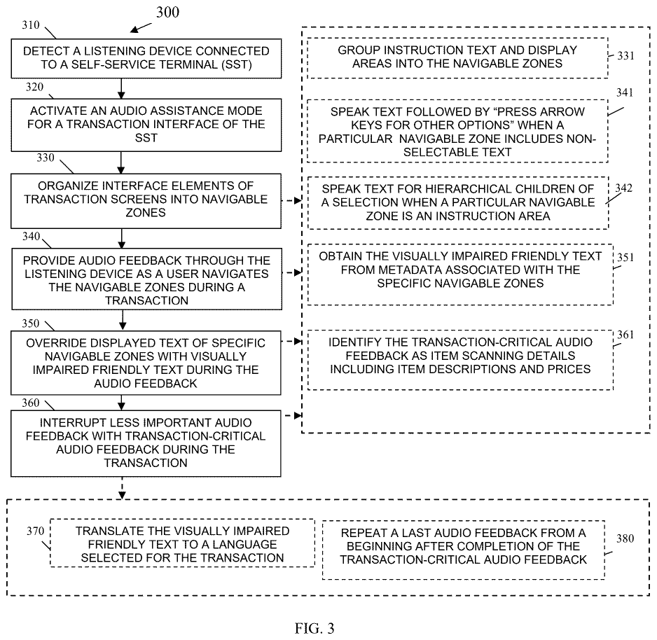

The above-referenced embodiments and other embodiments are now discussed within FIGS. 2-3. FIG. 2 is a flow diagram of a method 200 for an audio-enhanced transaction through a transaction interface of an SST, according to an example embodiment. The software module(s) that implements the method 200 is referred to as an “audio feedback manager.” The audio feedback manager is implemented as executable instructions programmed and residing within memory and/or a non-transitory computer-readable (processor-readable) storage medium and executed by one or more processors of one or more devices. The processor(s) of the device that executes the audio feedback manager are specifically configured and programmed to process the audio feedback manager. The audio feedback manager may have access to one or more network connections during its processing. The network connections can be wired, wireless, or a combination of wired and wireless.

In an embodiment, the device that executes the audio feedback manager SST 110. In an embodiment, the SST 110 is a kiosk, an automated teller machine (ATM), or a self-checkout (SCO) terminal. In an embodiment, the audio feedback manager is all or some combination of transaction manager 113, transaction UI 114, and/or audio enhancement manager 115.

At 210, the audio feedback manager detects an insertion of a listening device into an audio jack at an SST 110. In an embodiment, the listening device is a user's headset. In an embodiment, the audio jack is a port on an input control/navigation device 117.

At 220, the audio feedback manager switches a transaction interface of the SST 110 to a text-to-speech mode of operation based on detection of the insertion of the listening device. In an embodiment, at 221, the audio feedback manager routes audio to the listening device when the speech-to-text mode of operation is activated.

At 230, the audio feedback manager suppresses existing workflow audio when the speech-to-text mode is activated. That is, the audio feedback manager selectively suppresses and selectively plays the existing workflow audio based on a context of navigation by the user through UI screens of the transaction interface.

At 240, the audio feedback manager provides a navigation-focused audio through the listening device as a user navigates to interface elements within screens of the transaction interface using an input control device 117. In an embodiment, at 241, the audio feedback manager speaks displayed text of a navigated-to interface element when a particular interface element is not a selectable button.

In an embodiment, at 242, the audio feedback manager speaks text of a navigated-to interface element followed by a word “button” when a particular interface element is a selectable button. In an embodiment, at 243, the audio feedback manager speaks metadata text associated with a particular interface element instead of displayed text when the metadata text exists for the particular interface element. In an embodiment, at 244, the audio feedback manager speaks guidance text after speaking text associated with a selectable button indicating available navigation options.

At 250, the audio feedback manager interrupts a current playing audio when an item is sold during a transaction to provide item selling audio for details of the item. In an embodiment, at 251, the audio feedback manager fades out the currently playing audio before playing the item selling audio. In an embodiment, at 252, the audio feedback manager speaks an item description, price, and any additional details as the item selling audio.

At 260, the audio feedback manager resumes the current playing audio from a beginning after the item selling audio completes. In an embodiment, at 270, the audio feedback manager makes instruction areas of screens focusable controls that are navigable to using the input control device 117. In an embodiment, at 280, the audio feedback manager organizes interface elements into hierarchical navigation zones that are navigable through an input control device 117.

FIG. 3 is a diagram of another method 300 for an audio-enhanced transaction through a transaction interface of an SST, according to an example embodiment. The software module(s) that implements the method 300 is referred to as a “transaction voice guidance manager.” The transaction voice guidance manager is implemented as executable instructions programmed and residing within memory and/or a non-transitory computer-readable (processor-readable) storage medium and executed by one or more processors of a device. The processors that execute the transaction voice guidance manager are specifically configured and programmed for processing transaction voice guidance manager. The transaction voice guidance manager may have access to one or more network connections during its processing. The network connections can be wired, wireless, or a combination of wired and wireless.

In an embodiment, the device that executes the transaction voice guidance manager is SST 110. In an embodiment, the SST 110 is a kiosk, an ATM, or an SCO terminal. In an embodiment, the transaction voice guidance manager is all or some combination of transaction manager 113, transaction UI 114, audio enhancement manager 115, and/or method 200. The transaction voice guidance manager presents another and, in some ways, an enhanced processing perspective from that which was discussed above with method 200.

At 310, the transaction voice guidance manager detects a listening device connected to an SST 110. In an embodiment, the listening device is detected when a cord of a user's headset is plugged into an audio jack of an input control device 117.

At 320, the transaction voice guidance manager activates an audio assistance mode for a transaction interface of the SST 110. At 330, the transaction voice guidance manager organizes interface elements of transaction screens into navigable zones. In an embodiment, at 331, the transaction voice guidance manager groups instruction text and display areas into the navigable zones.

At 340, the transaction voice guidance manager provides audio feedback through the listening device as a user navigates the navigable zones during a transaction. In an embodiment, at 341, the transaction voice guidance manager speaks text followed by “press arrow keys for other options” when a particular navigable zone includes non-selectable text. In an embodiment, at 342, the transaction voice guidance manager speaks text for hierarchical children of a selection when a particular navigable zone is an instruction area.

At 350, the transaction voice guidance manager overrides displayed text of specific navigable zones with visually impaired friendly text during the audio feedback. In an embodiment, at 351, the transaction voice guidance manager obtains the visually impaired friendly text from metadata associated with the specific navigable zones.

At 360, the transaction voice guidance manager interrupts less important audio feedback with transaction-critical audio feedback during the transaction. In an embodiment, at 361, the transaction voice guidance manager identifies the transaction-critical audio feedback as item scanning details including item descriptions and prices.

In an embodiment, at 370, the transaction voice guidance manager translates the visually impaired friendly text to a natural language that is selected for the transaction. In an embodiment, at 380, the transaction voice guidance manager repeats a lost audio feedback from a beginning after completion of the transaction-critical audio feedback.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
detecting an insertion of a listening device into an audio jack at a self-service terminal (SST);
switching a transaction interface of the SST to a text-to-speech mode of operation based on detecting the insertion of the listening device;
suppressing a workflow audio when the text-to-speech mode is activated;
providing navigation-focused audio through the listening device as a user navigates to interface elements within screens of the transaction interface using an input control device;
interrupting a currently playing audio when an item is sold during a transaction to provide item selling audio for details of the item; and
resuming the currently playing audio from a beginning after the item selling audio completes.

2. The method of claim 1, wherein switching further includes routing all audio to the listening device when the text-to-speech mode is activated.

3. The method of claim 1, wherein providing further includes speaking displayed text of a navigated-to interface element when a particular interface element is not a selectable button.

4. The method of claim 1, wherein providing further includes speaking displayed text of a navigated-to interface element followed by a word for “button” when a particular interface element is a selectable button.

5. The method of claim 1, wherein providing further includes speaking metadata text associated with a particular interface element instead of displayed text when the metadata text exists for the particular interface element.

6. The method of claim 1, wherein providing further includes speaking guidance text after speaking text associated with a selectable button indicating available navigation options.

7. The method of claim 1, wherein interrupting further includes fading out the currently playing audio before playing the item selling audio.

8. The method of claim 1, wherein interrupting further includes speaking an item description, price, and any additional details as the item selling audio.

9. The method of claim 1 further comprising:
making instruction areas of screens focusable controls that are navigable to using an input control device.

10. The method of claim 1 further comprising:
organizing interface elements into hierarchical navigation zones that are navigable through an input control device.

11. A method, comprising:
detecting a listening device connected to a self-service terminal (SST);
activating an audio assistance transaction mode for a transaction interface of the SST;
organizing interface elements of transaction screens into navigable zones;
providing audio feedback through the listening device as a user navigates the navigable zones during a transaction;
overriding displayed text of specific navigable zones with visually impaired friendly text during the audio feedback; and
interrupting less important audio feedback with transaction-critical audio feedback during the transaction.

12. The method of claim 11, wherein organizing further includes grouping instruction text and display areas into the navigable zones.

13. The method of claim 11, wherein providing further includes speaking text followed by “press arrow keys for other options” when a particular navigable zone includes non-selectable text.

14. The method of claim 11, wherein providing further includes speaking text for hierarchical children of a section when a particular navigable zone is an instruction area.

15. The method of claim 11, wherein overriding further includes obtaining the visually impaired friendly text from metadata associated with the specific navigable zones.

16. The method of claim 11, wherein interrupting further includes identifying the transaction-critical audio feedback as item scanning details comprising item descriptions and prices.

17. The method of claim 11 further comprising:
translating the visually impaired friendly text to a language selected for the transaction.

18. The method of claim 11, further comprising:
repeating a last audio feedback from a beginning after completion of the transaction-critical audio feedback.

19. A system, comprising:
a self-service terminal (SST) comprising a universal navigator control device having an audio jack;
a transaction interface comprising screens having interface elements; and
an audio enhancement manager configured to:
detect when a listening device is inserted into the audio jack;
switch the transaction interface to a text-to-speech mode;
suppress transaction audio and provide navigation-focused audio feedback through the listening device as a user navigates the interface elements using the universal navigator control device,
interrupt a currently playing audio feedback to provide transaction-critical audio when a transaction event occurs, and
resume the currently playing audio feedback from a beginning after the transaction-critical audio completes.

20. The system of claim 19, wherein the universal navigator control device includes arrow controls for navigating the interface elements and a center button for selecting a navigated-to interface element.
